(19) United States
(12) Patent Application Publication
(10) Pub. No.: US 2025/0051105 A1
(43) Pub. Date: Feb. 13, 2025

(54) Directional Air Conveyance System and Method

(71) Applicant: Dan R. Lowrey, Durango, CO (US)

(72) Inventor: Dan R. Lowrey, Durango, CO (US)

(21) Appl. No.: 18/763,870

(22) Filed: Jul. 3, 2024

Related U.S. Application Data
(60) Provisional application No. 63/525,099, filed on Jul. 5, 2023.

(51) Int. Cl. B65G 51/03

(52) U.S. Cl. CPC B65G 51/03; B65G 2201/0252; B65G 2811/0673

(57) ABSTRACT

An air conveyance system and method for distributing and accumulating containers and moving containers along a distribution line generally has a horizontal planar surface perforated with a plurality of angular air holes, a blower fan, an airtight body, and an airflow controller. The blower moves air through the plurality of angular holes to create a cushion of air atop the horizontal planar surface powerful enough to float containers. The cushion of air is directional and can move, hold, and direct containers across the plane at various speeds.

### TECHNICAL FIELD

The present disclosure relates to air conveyance systems and methods and more specifically to an apparatus and method of accumulating containers and moving containers along a distribution line via a directional cushion of air atop a planar surface.

### CROSS-REFERENCE TO RELATED APPLICATION

This application claims the benefit of U.S. Provisional Application No. 63/525,099 filed Jul. 5, 2023.

### BACKGROUND

Containers are generally transported along a production line from a pallet to a processing stage along a conveyance line generally comprised of either a conveyor belt riding over two or more pulley or a series of rollers. The conveyance line is either driven by a motor or angled to permit gravity to move the container down the line. Further, there often exists a need to accumulate containers prior to further distributing containers for processing. The prior art has examples of both rectangular and orbital accumulation tables that accumulate number containers for distribution in single file for further processing.

### SUMMARY

The present invention relates to a directional air conveyance system and method for accumulating containers and moving containers along a distribution line. The invention relates to creating a cushion of air atop a flat plane powerful enough to float containers. The cushion of air is directional and can move, hold, and direct containers across the plane at various speeds.

Generally, the air conveyance system of the present invention has a planar surface upon which containers travel having a plurality of holes passing through the surface at an angle. Air is forced through the holes creating an air cushion on top of the planar surface that floats a container and causes it to travel in the direction of the angle of the plurality of holes. The air conveyance system for moving containers comprises a planar surface with an upper surface to support a container, a lower surface, and a plurality of air holes passing through the tabletop at an angle from the lower surface to the upper surface. The air conveyance system also has a substantially airtight body enclosing lower surface of the table that forces air from a blower through the plurality of air holes. The blower may have a restriction on its air intake, air outtake, or electric or mechanical control of the fan speed. The blower draws a desired air flow into the airtight body and through the plurality of holes in the planar surface. The containers float on a cushion atop the planar surface and the angle of the plurality of holes is dictates the direction and speed of travel of the container across the planar surface. The containers move in the same direction as the angle of the hole, and the containers will move faster or slower depending on the angle of the holes given the equivalent value of airflow volume pass though the plurality of holes. A more acute angle will result in faster container travel speeds given the equivalent value of airflow volume pass though the plurality of holes.

The present invention includes various methods of moving, holding, accumulating, and distributing containers by altering the airflow volume through the holes, the angle of the holes across the planar surface, and the direction of the angle of the holes across the planar surface. One method of air conveyance in the present invention has containers loaded onto the planer surface from the side of the planer surface and directed by airflow volume passing through the plurality of holes in a direction that turns a container to move longitudinally down the planer surface. One other method of the present invention includes sorting containers distributed across the planner surface into single file or a desire number of containers before exiting the planer surface. Still another method of the present invention includes containers, entering in a single file onto the planner surface, and then having a plurality of holes with such an angle to accumulate containers across the entirety of the planer surface before the containers exit. Still another method of the invention, containers are accumulated on a plainer surface, and remain on the planer surface until directed by a plurality of holes to exit the plan or surface in the desired direction. Still another method of the present invention, containers are directed up word on an angle, planer surface or downward on an angled planer surface, depending on the angle of the plurality of holes. In still another method of the president invention containers are directed up a spiraling surface to change elevation from the entrance of the spiral to the exit at the spiral. Each of these devices and methods will be better understood with reference to the accompanying drawings in detailed description of the embodiments.

### BRIEF DESCRIPTION OF THE ACCOMPANYING DRAWINGS

Having thus described an example embodiment of the present disclosure in general terms, reference will now be made to the accompanying drawings, which are not necessarily drawn to scale:

FIG. 1 is a side view of anisobaric motion of the present invention;

FIG. 2A is an isomeric view of the present invention;

FIG. 2B is an isomeric, exploded view of the present invention;

FIG. 3 is a top view of the present invention with arrows showing direction of travel;

FIG. 4A is a top view of an alternative embodiment of the present invention;

FIG. 4B is a side view of the planar surface of an alternative embodiment of the present invention;

FIG. 5 illustrates a top view of an alternative embodiment of the present invention;

FIG. 6 illustrates a top view of an alternative embodiment of the present invention;

FIG. 7A illustrates a top view of an alternative embodiment of the present invention with the containers exiting the planar surface in single file;

FIG. 7B illustrates a top view of an alternative embodiment of the present invention with the containers exiting the planar surface in single file in the middle of the surface;

FIG. 8 illustrates a top view of an alternative embodiment of the present invention with the containers accumulating;

FIG. 9A illustrates a side view of elevation change of the planar surface in an air conveyor;

FIG. 9B illustrates an alternative side view of elevation change of the planar surface in an air conveyor;

FIG. 10A illustrates an isomeric view of a spiral conveyer of the present invention with containers traveling down the conveyor;

FIG. 10B illustrates an isomeric view of a spiral conveyer of the present invention with containers traveling up the conveyor;

FIG. 11 illustrates a top view of the present invention utilized to accumulate containers on the planar surface.

FIG. 12 illustrates an isomeric view of a method for removing fallen containers of the present invention;

FIG. 13 illustrates a method of conveyance, accumulation, and sorting of containers of the present invention.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, apparatus and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. The use of any term should not be taken to limit the spirit and scope of embodiments of the present disclosure.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

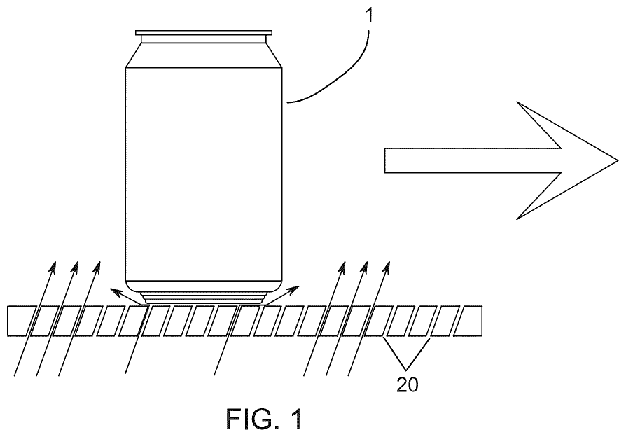

One embodiment of the present invention of an air conveyor 5 is comprised of a horizontal planar surface 10 having a grid of holes 20 drilled at an angle in the same orientation. Typically, the angle of the holes is 70 degrees. As shown in FIG. 1, when a container 1 is placed on the planar surface 10, the angled jetting of air creates an “anisobaric” condition beneath the object. An anisobaric condition as used to describe the present invention means and refers to a condition where the air pressure is higher on one end of the bottom surface of an object and lower at the other end of the bottom surface of the object. This anisobaric condition causes the Container 1 to float across the planar surface 10 in a singular direction, thus acting as an air conveyor system 5. There are a multitude of packages that could be moved via directional air conveyance. The following description relates generally to the movement and accumulation of aluminum cans along a packaging line.

The shape and design of modern aluminum beverage cans is well suited to air conveyance. The cans are formed such that the bottoms of the cans are concave in shape, and the cans are heavier at the bottom than the top. This allows an aluminum can to balance on an air cushion with a high degree of stability, although other light objects will also balance on an air cushion depending on their geometric shape and relative mass—the concave end of an aluminum can is not a requirement, simply a convenience. The beverage industry relies heavily on conveyance systems to move empty vessels from a bulk pallet, single file them into a line for filling and repackage them for sale post-fill. Another aspect of the beverage industry is can decorating services where empty cans are depalletized onto a conveyor, single-filed into a line for printing or labeling and then repalletized into bulk pallets.

An air cushion created by vertically oriented jets (holes bored at 90 degrees) on a non-level plane results in objects gliding downhill; therefore, angular jets on a level plane result in objects gliding on an air cushion at approximately the same angular velocity as if they were on a downhill grade. Although the invention relates to use a tilted table, the following description is directed to a horizontal planer surface with angular holes.

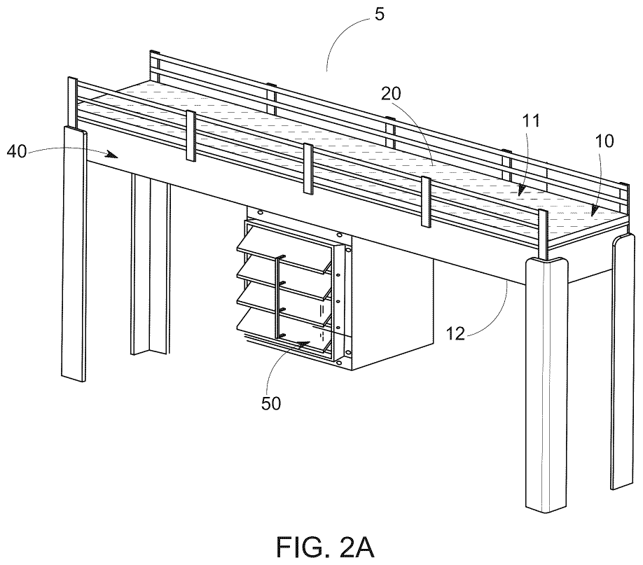

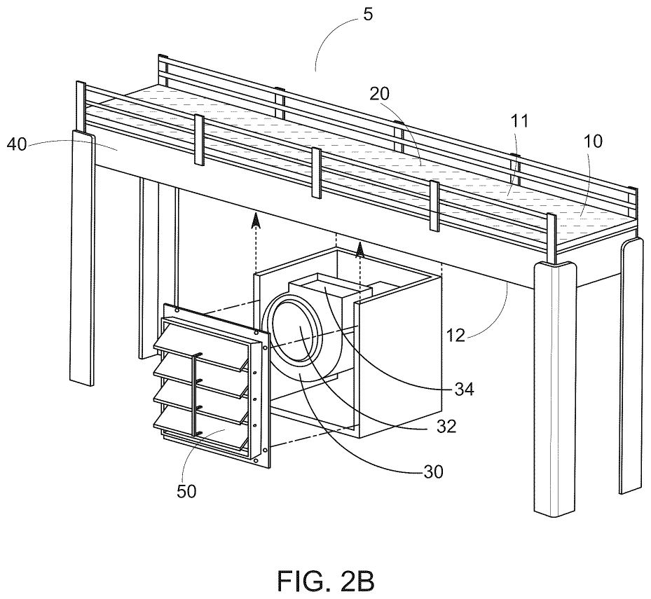

Referring to FIG. 2A, an air conveyor 5 of the present invention is generally shown. The air conveyor 5 is comprised of horizontal planar surface 10 perforated with a plurality of angular air holes 20. A blower fan 30, an airtight body 40, and louvers 50 for controlling airflow at the intake 32 of the blower 30 provide air through the holes. The planar surface 10 has an upper surface 11 that supports the containers and a lower surface 12 that communicates with the airtight body 40. The blower 30 pushes air through the airtight body 40 of the conveyor 5, distributing air to the upper surface of the planar surface 10 through the angular holes 20. The rate of flow and associated pressure through the angular holes 20 is governed by the louver 50 at the intake 32 of the blower 30. The louver 50 control the force applied to objects on the planar surface 10 and the speed at which they move across the surface 10 of the air conveyor 5. Air flow from the blower may be controlled at the intake 32, outtake 34, or by controlling the fan output.

The holes 20 may be stamped in the planar surface 10, drilled in the planar surface 10, molded in the planar surface 10, cut in the planar surface 10, or created in any common manufacturing technique.

Typically, conveyors in the food & beverage industry must be suitable for washdown and sanitation. Generally, conveyors are made from stainless steel, enameled mild steel or aluminum and whereas the lengths vary greatly, the widths do not. Conveyor widths of conveyors in the U.S. and Canada are available in 3.25″, 4.5″, 6″, 7.5″ 12″, 18″, 24″ and 36″.

The orientation of the angular holes 10 may vary greatly to suit different applications. In the case of a 12 oz. aluminum can, which has a highly stable geometry when subjected to an air cushion, the object can glide along a complex pattern, changing in vector with ease depending on the orientation of the plurality of angular air holes. Cans can be transported from one place to another, put into a recirculating pattern or even change grade gliding uphill or downhill simply by applying different bore angles.

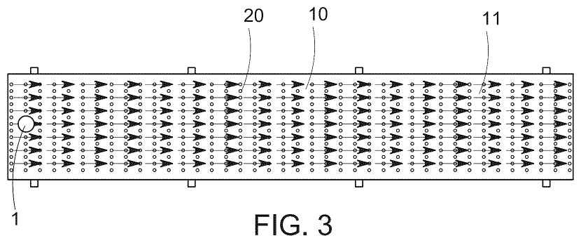

Referring to FIG. 3. The orientation of the angular holes 20 is consistent across the entirety of the planar surface 10. Thus, the container 1 will move in across the planar surface 10 in one direction, at one speed. As shown in other figures, the angle of the holes 20 and the direction of the angle of the hole 20 relative to the axis of the planar surface 10 may vary from region to region across the planar surface 10 allowing a container to change direction across the planar surface 10, speed up across the planar surface 10, or slow down or stop on the planar surface 10. Likewise, a container in one region on the planar surface 10 may move at a different speed or a different direction from another container in the planar surface 10.

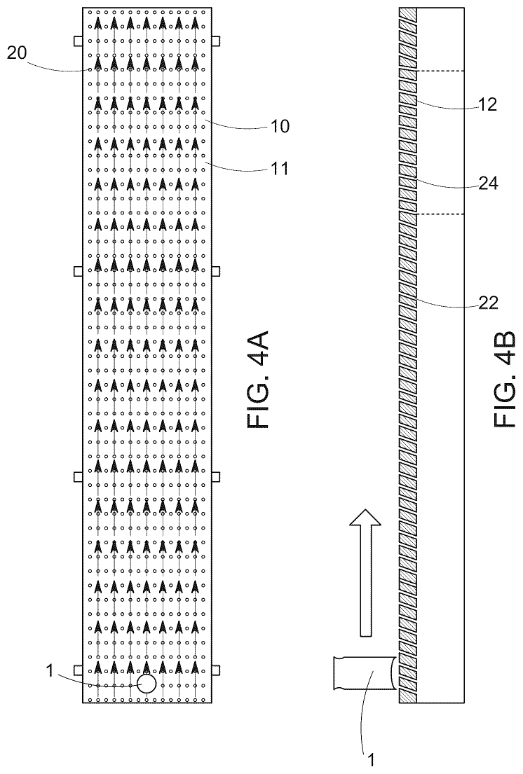

Referring to FIGS. 4A and 4B, the angle of the angular holes 20 is changed approximately ⅔ of the distance across the planar surface 10. Referring to FIG. 4B, a first set of angular holes 22 is more acute than a second set of angular holes 24. The angle becomes less acute causing the container 1 to slow relative to another area of the planar surface 10 with greater acuity in the angular holes 22. Thus, a container 1 traveling across the planar surface will maintain one speed across holes 22 and then slow in speed when encountering angular holes 24.

As described briefly above, the angle of the hole 20 and specific pattern of the holes 20 throughout regions of the planar surface 10 can address any number of exemplar application scenarios as shown in the figures.

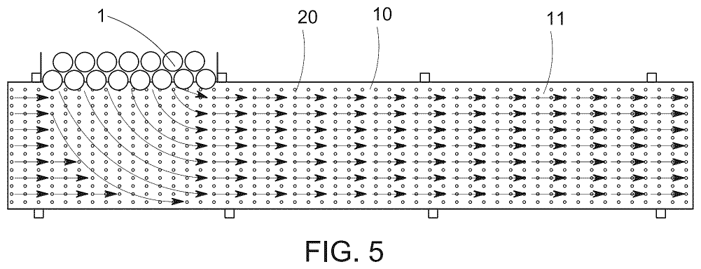

FIG. 5 illustrates a method of side transferring containers 1 onto an air conveyor 5 of the present invention. A nonlinear pattern of holes 20 that change in orientation on the planar surface 10 from a wide section to a linear pattern on a long axis accommodates a common application known in the industry as side transfer. In this way, containers 1 are depalletized or removed from a pallet onto the planar surface 10 perpendicular to the conveyor direction and the jetting through the holes 20 causes them to arch gently into the overall linear direction of the conveyor in a congruent order.

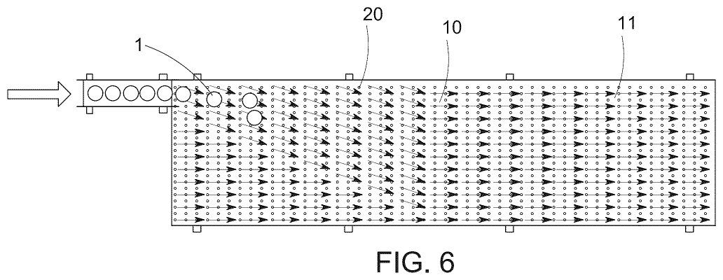

FIG. 6 illustrates a distribution of an air conveyor 5 of the present invention. nonlinear pattern of holes 20 spreading out from one point and moving into a singular direction in order to distribute a container 1 from a single file entry point to an even distribution on a broad air conveyor 5.

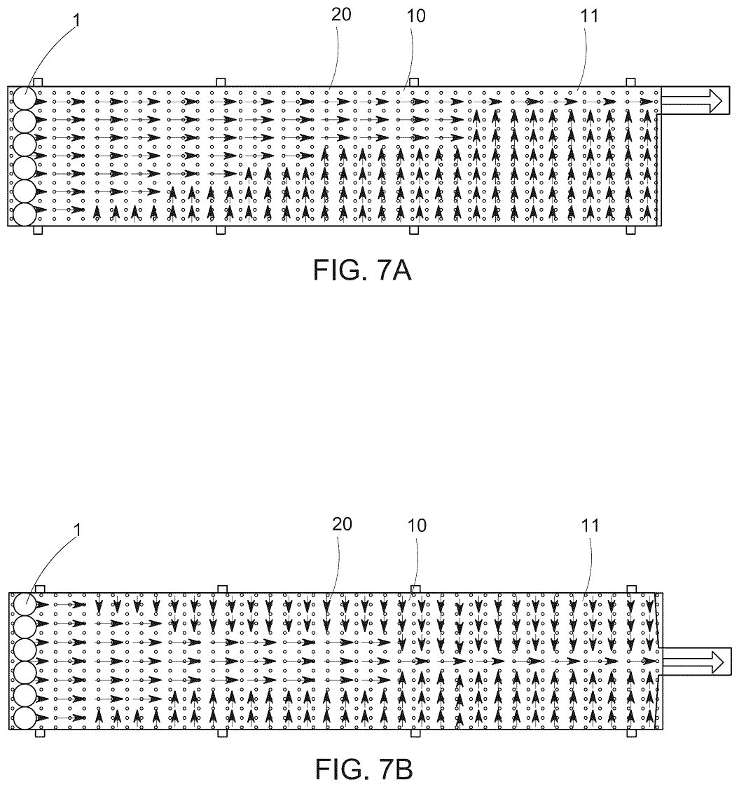

FIGS. 7A and 7B illustrate a single filing on an air conveyor 5 of the present invention. The planer surface 10 has a nonlinear pattern of holes 20 in the general shape of a funnel or single-sided slope. As containers come off a pallet in onto the planer surface 10 using either a manual method or an automated method such as a depalletizer, the non-linear pattern of holes 20 will cause containers 1 to conform to a single line as a glide down the conveyor 5. Single filing is a very common application, but by utilizing a directional air conveyor, it can be achieved without the use of side rails.

Referring to FIGS. 2A and 2B and FIG. 7A, in an embodiment of an air conveyor 5 of the present invention, the horizontal planar surface 10 includes two regions of angular air holes 20, a first region 26 and a second region 28. The planar surface 10 has a longitudinal axis and a latitudinal axis. A blower fan 30, an airtight body 40, and louvers 50 control the airflow of the blower 30 and distribute air to the planar surface 10 through the angular holes 26 and 28. The angular holes 26 are aligned along the longitudinal axis of the planar surface 10 to move containers 1 longitudinally along the planar surface 10. The angular holes 26 may have the same angle moving the container at the same speed across the planar surface 10 or have different angles with the more acute angle forcing the container across the planar surface 10 at a greater speed than a less acute angle. The angular holes 28 are aligned generally perpendicular to the longitudinal axis of the planar surface 10 to move containers 1 latitudinally across the planar surface 10. The angular holes 28 may have the same angle moving the container at the same speed across the planar surface 10 or have different angles with the more acute angle forcing the container across the planar surface 10 at a greater speed than a less acute angle. By varying the angle and or speed of the holes 26 and the holes 28, the air conveyor 5 can accumulate containers on the planar surface 10 and exit containers single file or in any desire orientation. One of skill in the art will also recognize that greater and fewer regions on the planar surface 10 of angled holes 20 can be utilized to move the containers in various directions at various speeds. Further the regions of angular holes 26 need not be along an edge of the planar surface 10 or exactly longitudinal to the axis of the planar surface 10 or of the same angle. One may move containers in a diagonal direction across the table. Likewise, regions of angular holes 28 may run on an angle other than 90 degrees to the longitudinal axis of the planar surface 10, regions may be larger or smaller across the planar surface, and holes 28 may be at different angles. Further, the diameter of the air holes 20 may vary across the table to control the volume of the air through the holes.

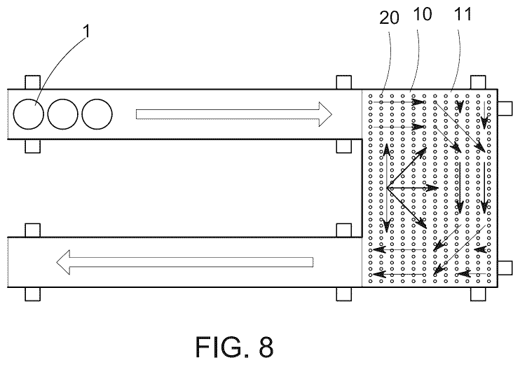

FIG. 8 illustrates a method of accumulating in distributing containers 1 in an air conveyor 5 of the present invention. Containers 1 are transported to a planar surface 10 via an air conveyor 5 of the present invention or another traditional conveyor. The planar surface 5 has a distribution of holes 20 to accumulate and distribute containers around the planar surface to exit the planar surface 10 in the opposite direction from which the container entered. The planar surface 10 has numerous regions of holes 10 orientated in different direction and at different angles to the planar surface 10. The container may exit on a traditional conveyor or an air conveyor 5 of the present invention. Much less room is required to turn or bend an air conveyor line than would be needed for a standard belt conveyor.

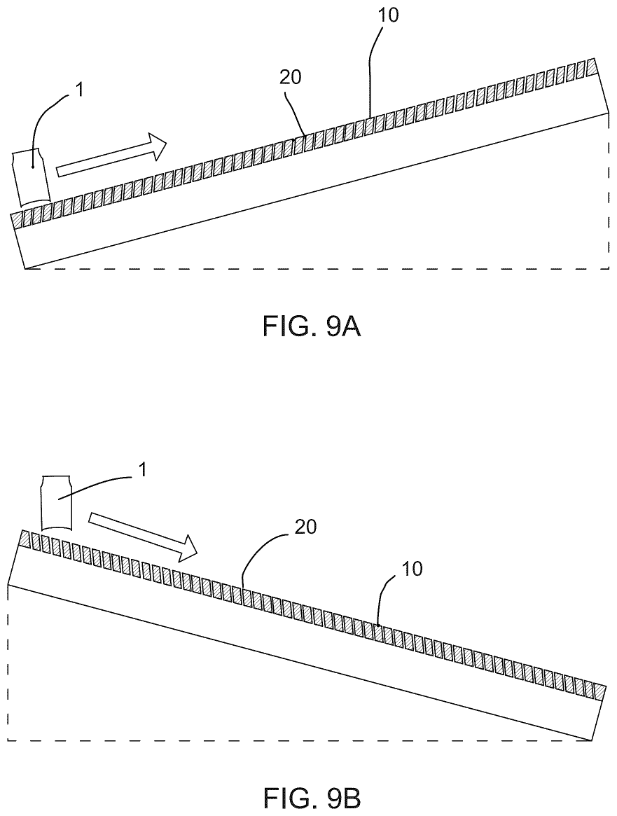

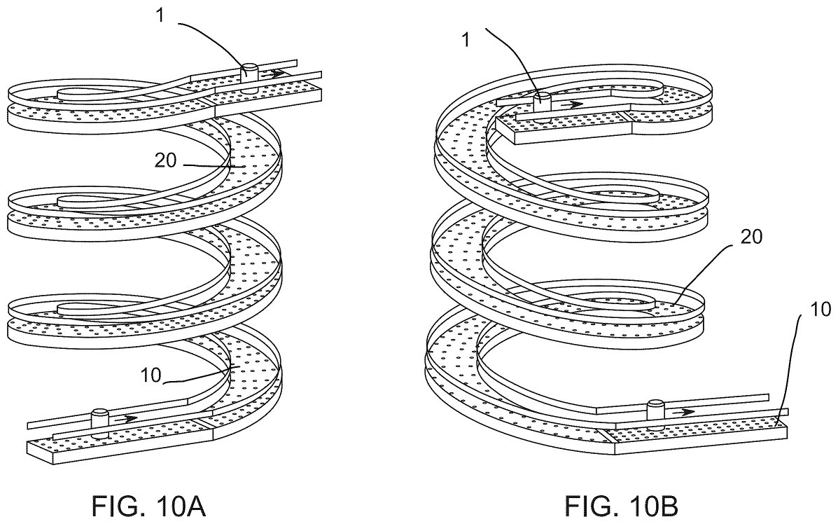

FIG. 9A and FIG. 9B illustrate elevation change in an air conveyor 5 of the present invention. By designing a directional air conveyor 5 to a specific container and a specific angle of grade, the conveyor can move an object up or down in elevation. This can either be done as a ramp or as a spiral conveyor (FIG. 10A and FIG. 10B) or in a combination of geometries.

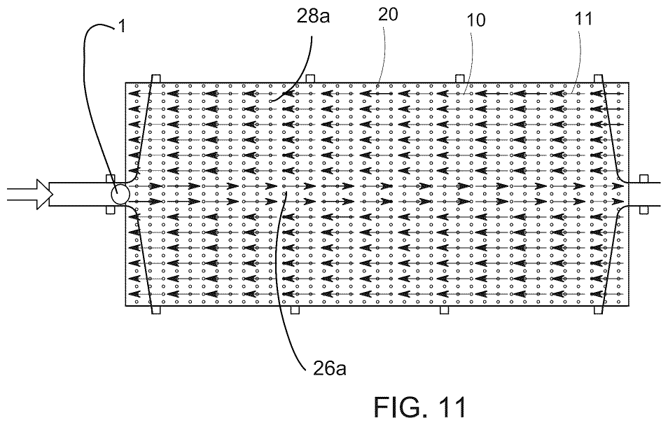

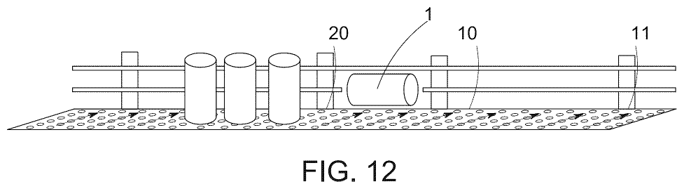

FIG. 11 illustrates an air conveyor 5 used as an accumulator of the present invention. A common feature of most high-volume packaging lines is a zone where containers are accumulated to accommodate varying speeds in different parts of the line. By incorporating a pattern of holes 20 to create a conveyor that has an entry point, a recirculating zone and an exit point, the air conveyor acts as an accumulator, holding a population of containers 1 until the line moves forward at a higher feed rate.

Referring again to FIG. 2A and FIG. 11, the air conveyor 5 of the present invention can accumulate and distribute containers 1. Containers 1 are loaded on to the horizontal planar surface 10 by hand or with a depalletizer. The planar surface 10 includes the plurality of angular air holes 26a, 28a. A first region of linear direction angular air holes 26a traverses the middle of planar surface 10 to force containers 1 from one end of the planar surface 5 to the other. A second region of linear direction angular air holes 28a are angled in the opposite direction of the first set of holes 26a, are located in the planar surface 10 on either side of the first set of holes 26a and direct a container 1 from in the opposite direction of the first set of holes 26a. A blower fan 30, an airtight body 40, and louvers 50 controls airflow through the holes 26a and 28a. Although not required, guides 60 may be used to redirect containers 1 from the first set of holes 26a to the second region of hole 28a and vice versa at each end of the planar surface 10. The blower 30 pushes air through the airtight body 40 of the conveyor 5, distributing air to the upper surface of the planar surface 10. Containers 1 are directed down the planer surface 10 and exit the planar surface 10 along the first region of holes 26a. Containers 1 that are forced off the first region of holes 26 travel back up the planar surface 10 on the second region of holes 28a. Since the second region of holes 28a generally occupies a greater percentage of the surface area of the planar surface 10, containers 1 are accumulated on the table prior to exiting the planar surface 10. This permits more containers 1 to be removed from a pallet and circulate on a table than a conveyor that only has a single file conveyance feature. The speed of movement can be regulated across the entire planar surface 10 by regulating the air volume from the blower 20. The speed of movement in various regions of the planar surface 10 may be regulated by varying the acuity of the angle of the region of holes 26a and the region of holes 28a.

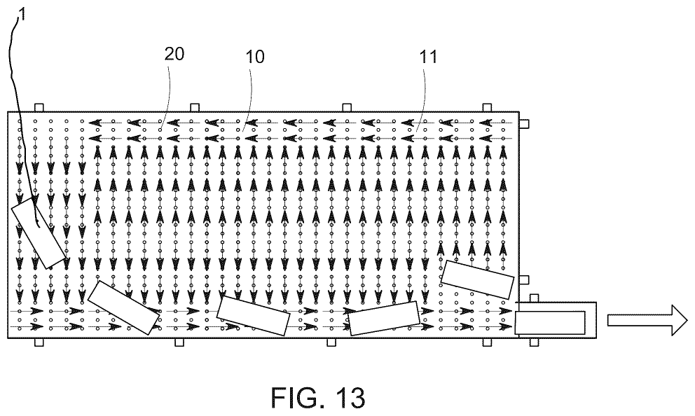

FIG. 13 illustrates downed container 1 rejection in an air conveyor 5 in the present invention. In the beverage industry, as empty vessels are conveyed to the filling machine there is an inevitability that a can will fall sideways. It is common to have a section on the line where a downed can is automatically rejected from the conveyor. Through the use of guide rails and a pattern of holes 20 oriented slightly off axis, a downed can may be rolled off the line on an air conveyor.

Although the present invention has be described with a louver 50 controlling the airflow volume from the blower 30 through the angular holes 20, other means of controlling airflow volume through the angular holes 20 are within the scope of the present invention. The louver 50 may control air flow at the intake 32 of the blower 30. The louver 50 may control output of the blower 30. Electric control of blower 30 using pulse width modulation (PWM) of the blower 30 can also control the air volume from the blower eliminating the need for the louver 50.

FIG. 14 illustrates pack orientation in an air conveyor of the present invention. By orienting the holes 20 in a pattern specific to the shape and desired path of a container, the air conveyor 5 can be used to orient an object to a uniform position and either recirculate or reject an object which does not conform.

What is claimed is:

1. An air distribution system for moving containers comprising:
a planar surface having an upper surface configured to support a container, a lower surface, and a plurality of air holes passing through the planar surface at an angle from the lower surface to the upper surface;
a substantially airtight body enclosing lower surface of the table;
a blower having an intake and outlet, the outlet in communication with the airtight body to move air through the plurality of air holes;
an air volume control for controlling airflow into the airtight body so that a desired amount of air passes through air holes of the tabletop to float the container and move the container across the upper surface of the tabletop in the same direction as the angle of the plurality of air holes;
wherein the angle of the air holes relative to the upper surface of the planar surface varies in a region of the planar surface.

2. The system of claim 1, wherein the plurality of air holes is aligned linearly along the longitudinal axis of the planar surface.

3. The system of claim 1, wherein the alignment of plurality of air holes varies in different regions relative to the longitudinal axis of the planar surface.

4. The system of claim 1, wherein a first region of air holes has the angle of holes relative to the upper surface of the planar surface substantially aligned parallel to the longitudinal axis of the planar surface and a second region of air holes has the angle of holes relative to the upper surface of the planar surface substantially aligned perpendicular to the longitudinal axis of the planar surface.

5. The system of claim 4 such that the containers exit the planar surface in a single file.

6. A method for distributing containers comprising:
loading containers on a first end of a planar surface having an upper surface configured to support containers, a lower surface, and a plurality of air holes passing through the planar surface at an angle from the lower surface to the upper surface, the plurality of air holes are arranged in a first region whereby the angle of the airhole is substantially aligned with the longitudinal axis of the planar surface and a second region whereby the angle of the airhole is not substantially aligned with the longitudinal axis;
creating air flow from a blower, the volume of air exiting the blower is regulated by a controller; and
moving containers off a second end of the planar surface by forcing air from the blower into an airtight body and through the air holes so that containers move from where they are loaded on the first end of the planar surface to the second end of the planar surface via the first region of air holes.

7. The method of claim 6, wherein the containers exit the second end of the planar surface in a single file order.

8. The method of claim 6, wherein the angle of the air holes in the planar surface varies so that containers vary speed while moving across the planar surface.

9. The method of claim 6, wherein the containers are loaded onto the planar surface from the side of the planar surface and the angle of the first region of air holes is substantially aligned perpendicular to the longitudinal axis of the planar surface.

10. The method of claim 6, where in the first end of the planar surface is at a different elevation than the second end of the planar surface.

11. A method for distributing containers comprising:
loading containers on a first end of a planar surface having an upper surface configured to support containers, a lower surface, and a plurality of air holes passing through the planar surface at an angle from the lower surface to the upper surface, the plurality of air holes are arranged in a first region whereby the angle of the airhole is substantially aligned with the longitudinal axis of the planar surface and a second region whereby the angle of the airhole is substantially in the opposite direction of the air holes in the first region;
creating air flow from a blower, the volume of air exiting the blower is regulated by a controller; and
moving containers off a second end of the planar surface by forcing air from the blower into an airtight body and through the air holes so that containers move from where they are loaded on the first end of the planar surface around the planar surface and eventually off to the second end via the first region of air holes.

12. The method of claim 11, wherein the first end of the planar surface has a first guide to direct containers towards the second end, and the second end of the planar surface has a second guide to direct containers towards the first end.

13. The method of claim 11, wherein the containers exit the second end of the planar surface in a single file order.

14. The method of claim 11, wherein the angle of the air holes in the planar surface varies so that containers vary speed while moving across the planar surface.

15.

16. The method of claim 11, where in the first end of the planar surface is at a different elevation than the second end of the planar surface.
